(19) United States
(12) Patent Application Publication
(10) Pub. No.: US 2025/0269339 A1
(43) Pub. Date: Aug. 28, 2025

(54) CUP LINER FOR BLENDER

(71) Applicant: Jonathan KIM, Cashmere, WA (US)

(72) Inventor: Jonathan KIM, Cashmere, WA (US)

(21) Appl. No.: 19/198,148

(22) Filed: May 5, 2025

Related U.S. Application Data
(63) Continuation-in-part of application No. 17/385,115, filed on Jul. 26, 2021, now Pat. No. 12,295,527.

(51) Int. Cl. B01F 35/511; A47J 43/046; A47J 43/07; B01F 27/808; B01F 35/32; B01F 101/00

(52) U.S. Cl. CPC B01F 35/511; A47J 43/046; A47J 43/0716; B01F 27/808; B01F 35/3204; B01F 35/3213; B01F 2101/1805

(57) ABSTRACT

A liner can include a body dimensioned to fit within a cup of a blender and defining an inner volume and including an opening with a perimeter; a lip extending outward from the perimeter of the opening and dimensioned to engage a perimeter of an opening of the cup, such that when the liner is positioned within the cup, the resulting assembly is capable of being mechanically coupled with a blending assembly of the blender and provide a seal for the inner volume; and a lip-end structure configured to retain the lip of the liner relative to the perimeter of the of the opening of the cup when the liner is positioned within the cup, with the lip-end structure having a side-sectional shape that includes an inward-facing surface dimensioned to prevent inward lateral motion of the lip beyond the perimeter of the opening of the cup without a removing force.

### CROSS-REFERENCE TO RELATED APPLICATION(S)

This application is a continuation-in-part of U.S. application Ser. No. 17/385,115 filed Jul. 26, 2021, entitled CUP LINER FOR BLENDER, the benefits of the filing date of which is hereby claimed and the disclosure of which is hereby expressly incorporated by reference herein in its entirety.

### BACKGROUND

### Field

The present disclosure relates to devices, assemblies and methods associated with cup liners for blenders.

### Description of the Related Art

A blender typically includes a base unit having a motor and configured to receive a container. Such a container is dimensioned to receive a volume of ingredient(s) to be blended by a blade assembly positioned on one end of the container and powered by the motor when the container is mounted on the base unit.

For some blenders, an end of a container where a blade assembly is positioned is dedicated for mounting the container onto a base unit. Accordingly, such a container typically includes a lid assembly on the other end (e.g., on the upper portion of the container when the container is mounted on the base unit) to allow one or more unblended ingredients to be introduced into the container and to allow a blended mixture to be removed from the container.

For some blenders, a container has an opening on one end for introducing one or more unblended ingredients into the container and for removing a blended mixture from the container. The same end of the container is configured to mate with a blade assembly that is in turn configured to allow the container to be mounted onto a base unit for blending operation.

### SUMMARY

In some implementations, the present disclosure relates to a liner for a blender. The liner includes a body dimensioned to fit within a cup for the blender, and defines an inner volume and includes an opening with a perimeter configured to engage a perimeter of an opening of the cup. When the liner is positioned within the cup, the resulting assembly is capable of being mechanically coupled with a blade assembly to enclose the volume with one or more ingredients therein for blending operation by the blender.

In some embodiments, the perimeter of the liner can include a lip dimensioned to engage the perimeter of the cup and to allow the blade assembly to be mechanically coupled with the assembly of the liner positioned within the cup. In some embodiments, the lip of the liner can be configured such that the blade assembly, when mechanically coupled to the assembly of the liner positioned within the cup, forms a seal to contain the one or more ingredients within the liner during the blending operation. In some embodiments, the lip of the liner can include a feature configured to retain the perimeter of the liner relative to the perimeter of the cup when the liner is positioned within the cup. In some embodiments, the feature of the lip can include, for example, a bead structure.

In some embodiments, the body of the liner can include an inner surface and an outer surface such that the inner surface defines the inner volume and the outer surface faces an inner surface of the cup. In some embodiments, the outer surface of the liner can have a shape that is different than a shape of the inner surface of the cup. In some embodiments, the outer surface of the liner can have a shape substantially similar to a shape of the inner surface of the cup.

In some embodiments, the outer surface of the liner can have a shape selected to provide a substantial contact with the inner surface of the cup when the liner is positioned within the cup. In some embodiments, the outer surface of the liner can have a shape selected to provide a space between the liner and the inner surface of the cup when the liner is positioned within the cup. In some embodiments, the outer surface of the liner can include one or more features implemented to engage the inner surface of the cup to provide the space between the liner and the inner surface of the cup when the liner is positioned within the cup. In some embodiments, each of the one or more features of the outer surface of the liner can be dimensioned to reduce resistance of motion associated with trapped air when the liner is being inserted into or removed from the cup.

In some implementations, the present disclosure relates to a kit that includes a liner for a blender. The liner includes a body dimensioned to fit within a cup for the blender. The body defines an inner volume and includes an opening with a perimeter configured to engage a perimeter of an opening of the cup. When the liner is positioned within the cup, the resulting assembly is capable of being mechanically coupled with a blade assembly to enclose the volume with one or more ingredients therein for blending operation by the blender. The kit further includes a printed instruction configured to facilitate use of the liner.

In some embodiments, the kit can further include the cup. In some embodiments, the perimeter of the liner can include a lip dimensioned to engage the perimeter of the cup and to allow the blade assembly to be mechanically coupled with the assembly of the liner positioned within the cup. In some embodiments, the lip of the liner can include a feature configured to retain the perimeter of the liner relative to the perimeter of the cup when the liner is positioned within the cup. In some embodiments, the perimeter of the cup can include a recess dimensioned to accommodate the feature of the lip.

In some embodiments, the body of the liner can include an inner surface and an outer surface such that the inner surface defines the inner volume and the outer surface faces an inner surface of the cup. In some embodiments, the outer surface of the liner can have a shape substantially similar to a shape of the inner surface of the cup. In some embodiments, either or both of the outer surface of the liner and the inner surface of the cup can be configured to provide a space between the liner and the cup when the liner is positioned within the cup.

In some embodiments, the kit can further include the blade assembly. In some embodiments, the kit can further include a motor base configured to allow an assembly of the blade assembly mechanically coupled to the assembly of the liner and the cup to be mounted thereon for the blending operation.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a conventional blender that includes a base unit, a blade assembly and a container having one open end configured to mate with the blade assembly.

FIGS. 2A to 2F show various stages of an example blending process utilizing the blender of FIG. 1.

FIG. 3A shows an assembly that can be utilized with a base unit of a blender, with the assembly including a container, a liner and a blade assembly.

FIG. 3B shows a sectional view as indicated in FIG. 3A.

FIG. 3C shows an assembled view of the assembly of FIG. 3A.

FIG. 4A shows another assembly that can be utilized with a base unit of a blender, with the assembly including a container, a liner, a coupling extender and a blade assembly.

FIG. 4B shows a sectional view as indicated in FIG. 4A.

FIG. 4C shows an assembled view of the assembly of FIG. 4A.

FIGS. 5A to 5J show various stages of an example blending process utilizing the assembly of FIG. 4A.

FIG. 6 shows that in some embodiments, an assembly such as the assembly of FIG. 3A or FIG. 4A can be configured to provide one or more mechanical couplings among the parts.

FIG. 7 shows examples of mechanical couplings that can be implemented for the configuration of FIG. 6.

FIG. 8 shows an example where either or both of the container and the respective liner of FIG. 3A or FIG. 4A can be configured to allow the liner to be used with the container in a desirable manner.

FIG. 9A shows a sectional view as indicated in FIG. 8.

FIG. 9B shows a sectional view as indicated in FIG. 8.

FIGS. 10A and 10B show another example where either or both of the container and the respective liner of FIG. 3A or FIG. 4A can be configured to allow the liner to be used with the container in a desirable manner.

FIG. 11 shows that in some embodiments, a liner can include a side profile that is significantly different than a side profile of a corresponding cup.

FIG. 12A shows an example of a lip with of a liner, where the lip includes a bead structure at its lateral end to prevent inward lateral motion of the lip.

FIG. 12B shows an enlarged view of a portion of FIG. 12A.

FIG. 13A shows another example of a lip with of a liner, where the lip includes a downward angled bend at its lateral end to prevent inward lateral motion of the lip.

FIG. 13B shows an enlarged view of a portion of FIG. 13A.

FIG. 14A shows yet another example of a lip with of a liner, where the lip includes a downward curvature at its lateral end to prevent inward lateral motion of the lip.

FIG. 14B shows an enlarged view of a portion of FIG. 14A.

FIG. 15 shows an example where a liner having one or more features as described herein can be covered with a lid.

FIG. 16 shows an example where a liner having one or more features as described herein can be covered with a sealing film.

### DETAILED DESCRIPTION OF SOME EMBODIMENTS

The headings provided herein, if any, are for convenience only and do not necessarily affect the scope or meaning of the claimed invention.

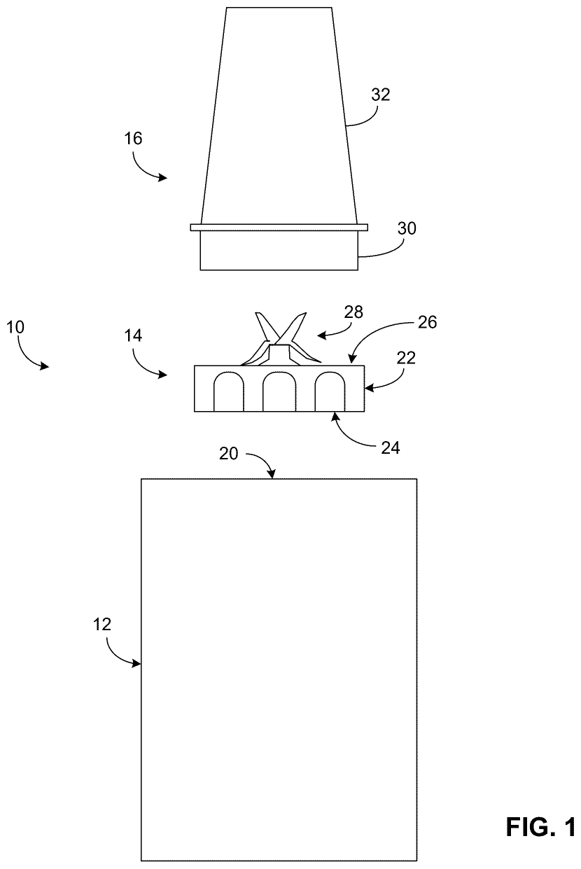

FIG. 1 depicts a conventional blender 10 that includes a base unit 12, a blade assembly 14 and a container 16. The container 16 has one open end with a mating portion 30 configured to mate with the blade assembly 14. The mating portion 30 is shown to be an extension of a cup portion 32 having a closed end opposite from the open end of the mating portion 30. Accordingly, the container 16 is sometimes referred to as a cup, and such a cup can be enclosed by securing the blade assembly 14 onto its open end.

Referring to FIG. 1, the blade assembly 14 is shown to include a cap 22 having a container side 26 and a base side 24, with a set of blades 28 implemented on the container side 26. The container side 26 of the cap 22 is configured to mate with the mating portion 30 of the container 16 in a removable manner, and the base side 24 of the cap 22 is configured to couple with a coupling portion 20 of the base unit 12. The set of blades 28 is typically coupled mechanically to an engagement mechanism on the base side 24 of the cap 22. Accordingly, when the cap 22 is coupled to the coupling portion 20 of the base unit 12, the set of blades 28 can be driven by an electric motor within the base unit.

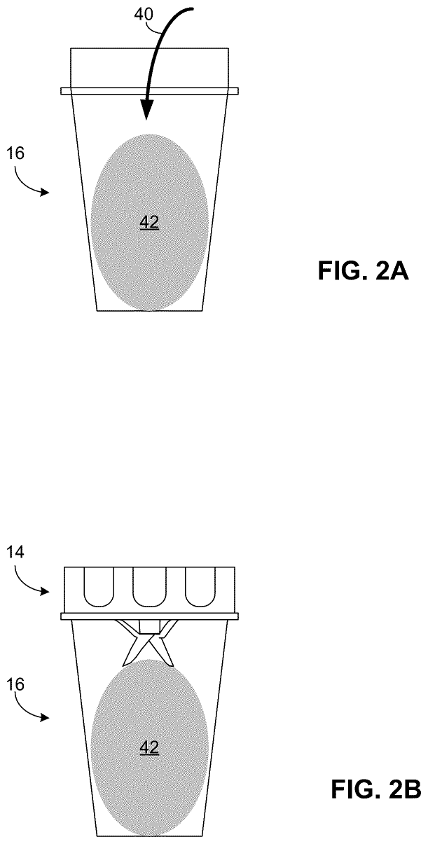

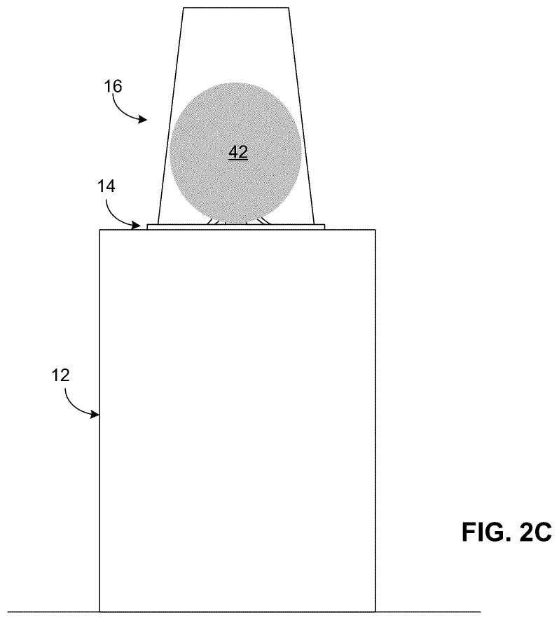

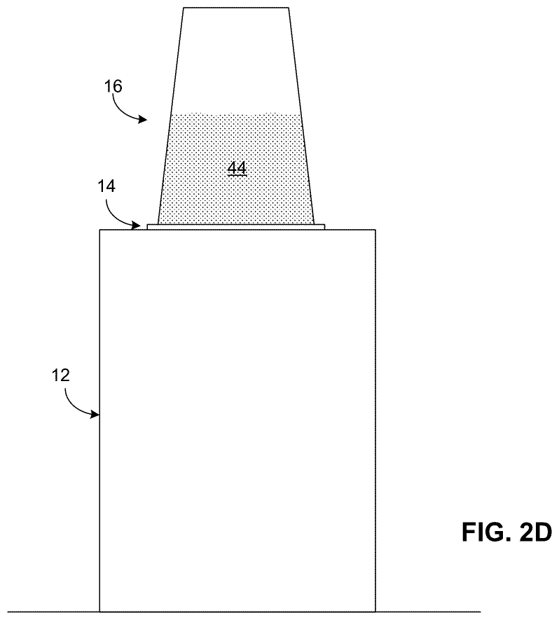

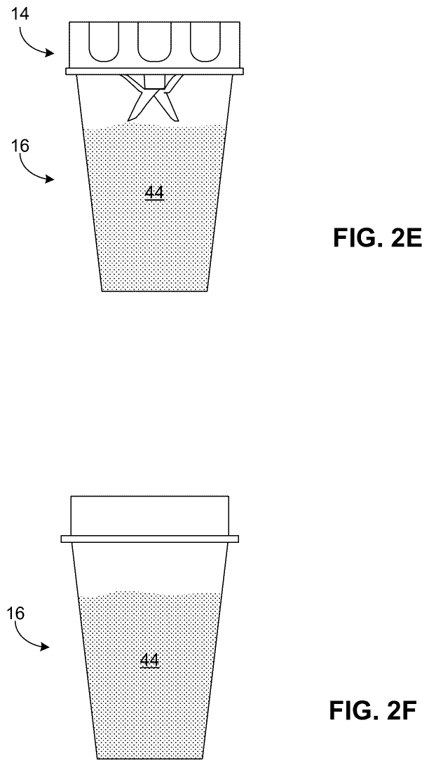

FIGS. 2A to 2F show various stages of an example blending process utilizing the blender 10 of FIG. 1. More particularly, FIG. 2A depicts a stage where a cup 16 is shown to be oriented (e.g., open end facing upward) to allow one or more ingredients to be introduced (depicted as arrow 40) into the cup 16 to result in a volume 42 of such ingredient(s).

FIG. 2B depicts a stage where a blade assembly 14 is shown to be secured to the open end of the cup 16 so as to provide an enclosed volume within the cup 16 with the ingredient(s) therein.

FIG. 2C depicts a stage where the assembly of FIG. 2B is shown to be inverted and positioned on a base unit 12. Due to the inverted orientation of the cup 16, some or all of the volume 42 of ingredient(s) comes in contact with a set of blades of the blade assembly, thereby allowing the volume 42 of ingredient(s) to be blended.

FIG. 2D depicts a stage where the volume 42 of ingredient(s) in FIG. 2C has been blended to provide a blended mixture 44.

FIG. 2E depicts a stage where the cup 16 with the blade assembly 14 still attached thereon has been removed from the base unit (12 in FIG. 2D) and returned to an orientation similar to the orientation of FIG. 2A. In such an orientation, the blended mixture 44 is shown to settle on the cup's floor, and thus away from the set of blades of the blade assembly 14.

FIG. 2F depicts a stage where the blade assembly (14 in FIG. 2E) has been removed from the open end of the cup 16. At this stage, the blended mixture 44 can be consumed directly from the cup 16, be removed through the open end of the cup 16, or some combination thereof.

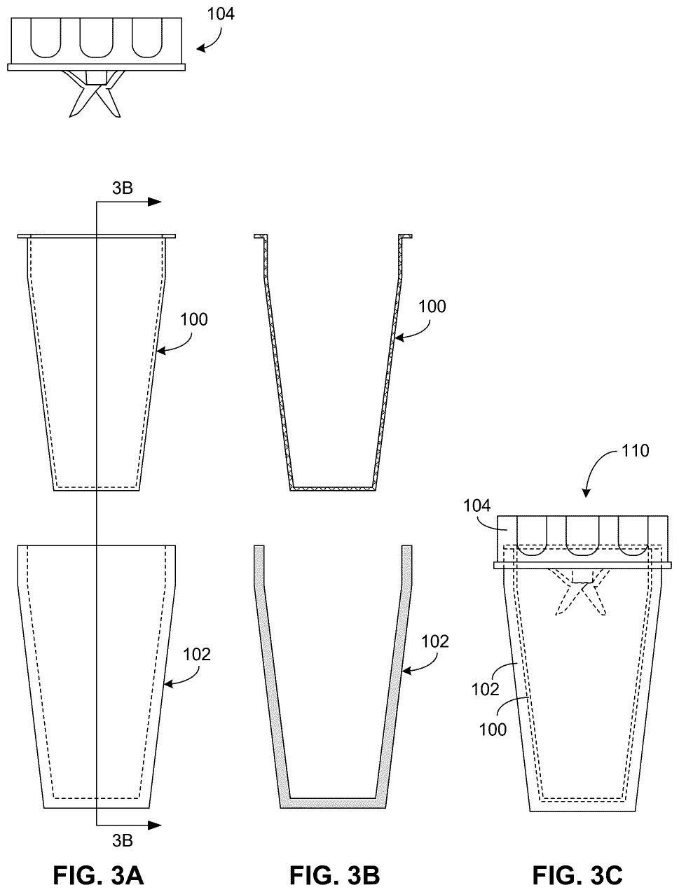

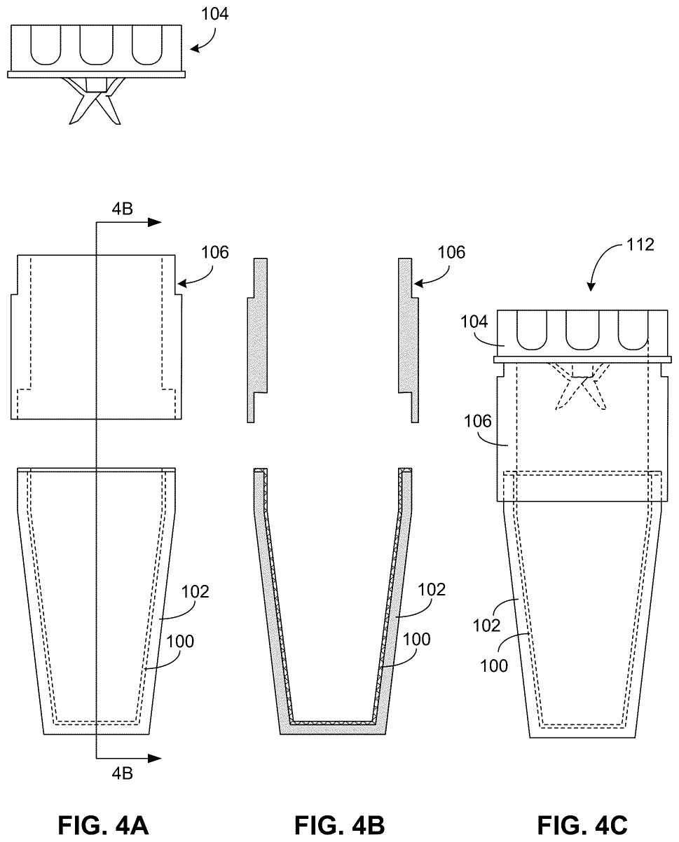

In some implementations, the present disclosure relates to a liner that can be utilized with a container (also referred to herein as a cup) of a blender. FIGS. 3A to 3C show an example of such a liner configured to be utilized with a cup. FIGS. 4A to 4C show another example of such a liner configured to be utilized with a cup and a coupling extender.

FIG. 3A shows that in some embodiments, a liner 100 having one or more features as described herein can be configured to be inserted into a cup 102, and a blade assembly 104 can be secured to the resulting assembly of the liner 100 and the cup 102. FIG. 3B shows a side sectional view as indicated in FIG. 3A, and FIG. 3C shows an assembled view of the FIG. 3A. Examples related to the liner 100 are described herein in greater detail.

In the example of FIGS. 3A to 3C, the blade assembly 104 is shown to be attachable to the upper opening of the cup 102. FIGS. 4A to 4C show that in some embodiments, a coupling extender 106 can be implemented between a cup 102 and a blade assembly 104.

More particularly, FIG. 4A shows that a liner 100 having one or more features as described herein can be configured to be inserted into a cup 102, and a coupling extender 106 can be secured to the resulting assembly of the liner 100 and the cup 102. Then, a blade assembly 104 can be secured to the coupling extender 106 to form an enclosed volume that is now increased due to the use of the coupling extender 106. FIG. 4B shows a side sectional view as indicated in FIG. 4A, and FIG. 4C shows an assembled view 112 of the assembly of FIG. 4A. Examples related to such an assembly are described herein in greater detail.

Referring to the examples of FIGS. 3 and 4, it is noted that in some embodiments, the blade assemblies 104 of FIGS. 3 and 4 can be substantially the same, such that a given blade assembly 104 can be utilized with (FIG. 4) or without (FIG. 3) the coupling extender 106. It is also noted that in some embodiments, the blade assemblies 104 of FIGS. 3 and 4 are different, such that the blade assembly 104 associated with one configuration (e.g., FIG. 4) may not be utilized with the other configuration (e.g., FIG. 3).

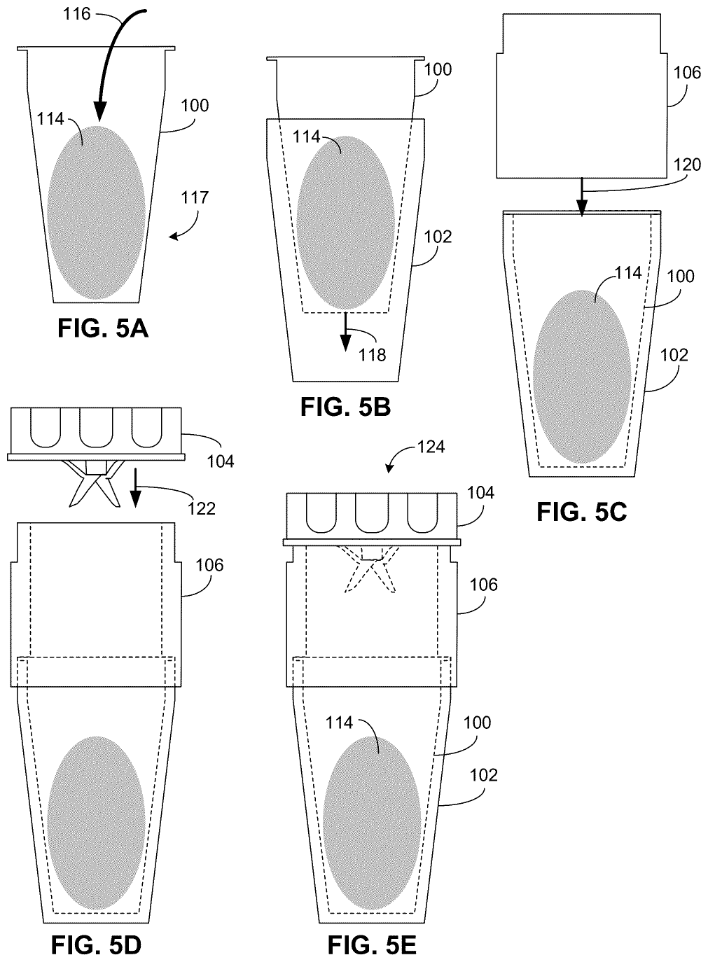

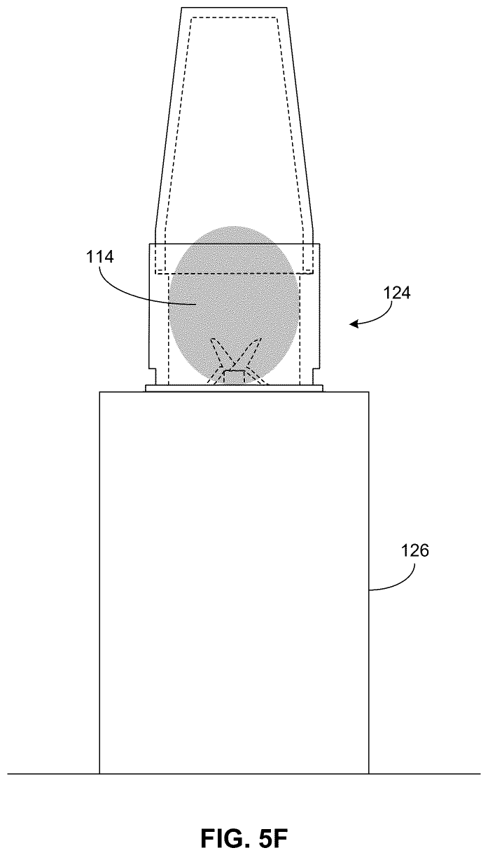

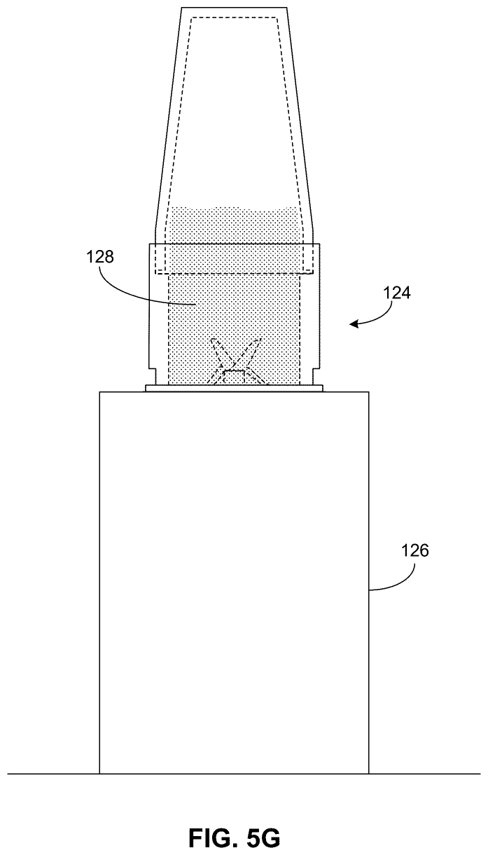

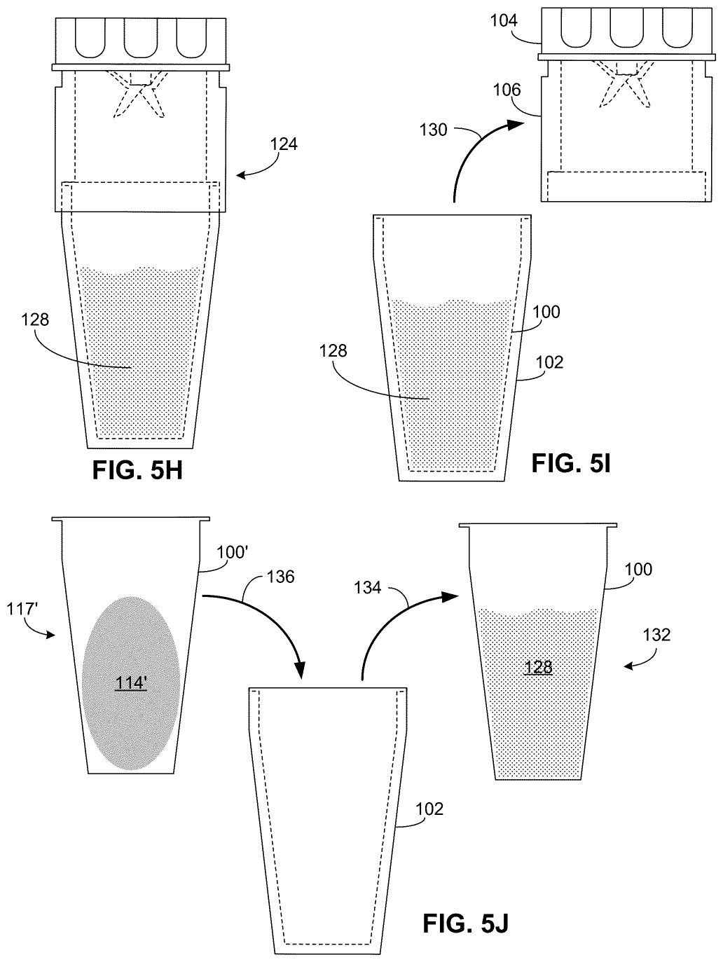

FIGS. 5A to 5J show an example of how the configuration of FIG. 4 can be utilized to perform a blending operation. In FIG. 5A, an assembly 114 of one or more ingredients to be blended is shown to be introduced (indicated as arrow 116) into a liner 100 so as to form an assembly 117.

In FIG. 5B, the assembly 117 of FIG. 5A is shown to be introduced (indicate as arrow 118) to a cup 102 dimensioned to receive the liner 100. In FIG. 5C, a coupling extender 106 is shown to be provided over the cup/liner assembly of FIG. 5B, as indicated by arrow 120.

In FIG. 5D, a blade assembly 104 is shown to be introduced over the coupling extender 106, as indicated by arrow 122. In FIG. 5E, the blade assembly 104 is shown to be secured onto the coupling extender so as to provide an assembly 124. At this stage, the assembly 124 may be inverted to allow the one or more ingredients 114 to be introduced to a blade of the blade assembly (104 in FIG. 5E).

In FIG. 5F, the assembly 124 of FIG. 5E, now inverted, is shown to be mounted onto a motor base 126. In such an inverted orientation, the blade of the blade assembly can be driven by the motor base 126 and engage the one or more ingredients 114 to perform a blending operation.

FIG. 5G shows a stage where the blending operation of FIG. 5E has been performed to yield a blended mixture 128. The assembly 124 with the blended mixture 128 contained therein can then be removed from the motor base 126.

FIG. 5H shows the assembly 124 removed from the motor base 126 and in an upright orientation of the liner/cup (100/102 in FIG. 5E) assembly. In such an orientation, the blended mixture 128 is shown to generally settle within the liner 100.

In FIG. 51, the coupling extender 106 with the blade assembly 104 attached thereto is shown to be removed (arrow 130) from the liner/cup (100/102) assembly.

In FIG. 5J, an assembly 132 of the liner 100 with the blended mixture 128 therein is shown to be removed (arrow 134) from the cup 102. It will be understood that the blended mixture 128 can then be consumed directly from the liner 100, be transferred to a separate container for consumption, or some combination thereof.

FIG. 5J further shows an assembly 117′ that includes one or more ingredients 114′ within a liner 100′, similar to the assembly 117 of FIG. 5A. Such an assembly (117′) can be introduced into the cup 102 for a blending operation as described herein.

In some embodiments, the liner 100′ of FIG. 5J may be the same liner 100 that was removed from the cup 102 (with the blended mixture 128 consumed/removed), or a different liner. In the latter case, one can see that use of liners having one or more features as described herein provides improved utility of a blender including, for example, increase in throughput of blending operations and reduced likelihood of cross-contamination associated with the cup 102.

In the various examples described herein in reference to FIGS. 5A to 5J, a coupling extender 106 is utilized. It will be understood that such a coupling extender may or may not be utilized with a liner 102 having one or more features as described herein. For example, the step depicted in FIG. 5C may be omitted, and in FIGS. 5D to 51, the coupling extender 106 may be omitted such that the blade assembly 104 engages the cup/liner assembly without any extender.

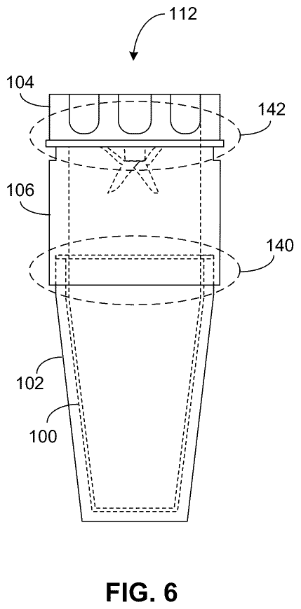

FIG. 6 shows an assembly 112 similar to the assembly 112 of FIG. 4C. FIG. 6 also shows that in some embodiments, a coupling mechanism 140 can be provided between a coupling extender 106 and a cup/liner (102/100) assembly, and a coupling mechanism 142 can be provided between a blade assembly 104 and the coupling extender 106.

In some embodiments, the coupling mechanisms 140 and 142 may or may not be similar. In the former case where the coupling mechanisms 140 and 142 are similar, the blade assembly 104 can be coupled to the cup/liner (102/100) assembly through the coupling extender 106 as shown, or be coupled directly to the cup/liner (102/100) assembly without a coupling extender.

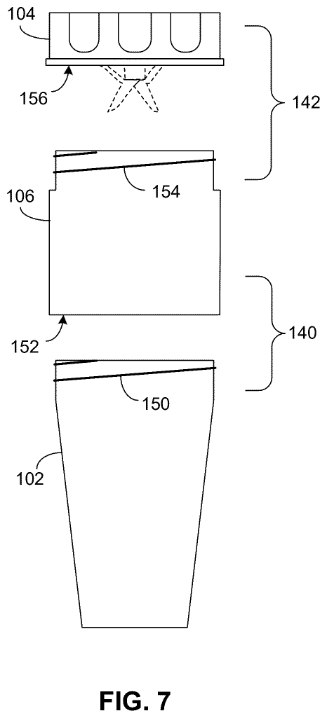

FIG. 7 shows that in some embodiments, threaded coupling mechanism can be provided for each of the coupling mechanisms 140 and 142 of FIG. 6. For example, the coupling mechanism 140 between the coupling extender 106 and the cup/liner (102/100) assembly can include a thread feature 150 implemented on the outer surface of the upper portion of the cup 102, and a matching thread feature 152 implemented on the inner surface of the lower portion of the coupling extender 106. In another example, the coupling mechanism 142 between the blade assembly 104 and the coupling extender 106 can include a thread feature 154 implemented on the outer surface of the upper portion of the coupling extender 106, and a matching thread feature 156 implemented on the inner surface of the blade assembly 104. For the purpose of description of FIG. 7, it will be understood that upper and lower portions are in the context of the example orientation of the assembly of parts as depicted in FIG. 7.

Referring to the example of FIG. 7, it is noted that if the thread features 150/152 are similar to the thread features 154/156, the coupling extender 106 may or may not be utilized for blending operations as described herein.

It will be understood that either or both of the coupling mechanisms 140 and 142 can be configured in other manners. For example, coupling mechanisms such as bayonet mechanism, friction mechanism, etc., may be utilized.

In the various examples shown in FIGS. 3 to 7, the outer shape of a liner 100 is depicted as having the inner shape of a corresponding cup 102, such that when the liner 100 is inserted into the cup 102, the liner 100 fits substantially flush within the cup 102. It is noted that if the outer shape of the liner 100 and the inner shape of the cup 102 have smooth surfaces, it may be difficult for air to move between the liner 100 and the cup 102 when the liner 100 is being inserted into and/or removed from the cup 102. For example, air may become trapped between the liner 100 and the cup 102, thereby resulting in the liner 100 not being fully seated within the cup 102. In another example, when the liner 100 is being removed from the cup 102, a seal may have formed therebetween, thereby resulting in the liner 100 being difficult to remove. It is noted that liquid such as water can provide issues similar to air.

Accordingly, it will be understood that for the purpose of description, a fluid can include a gas such as air, a liquid such as water, or any combination thereof.

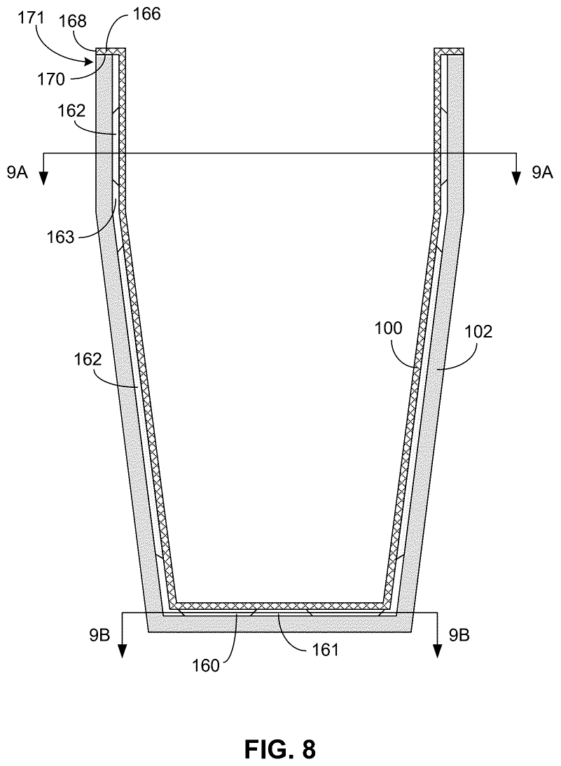

FIG. 8 shows that in some embodiments, either or both of a liner and a corresponding cup can include one or more features that allow improved movement of a fluid between the liner and the cup. Accordingly, such feature(s) can allow the liner to be inserted into and removed from the cup in an easier manner.

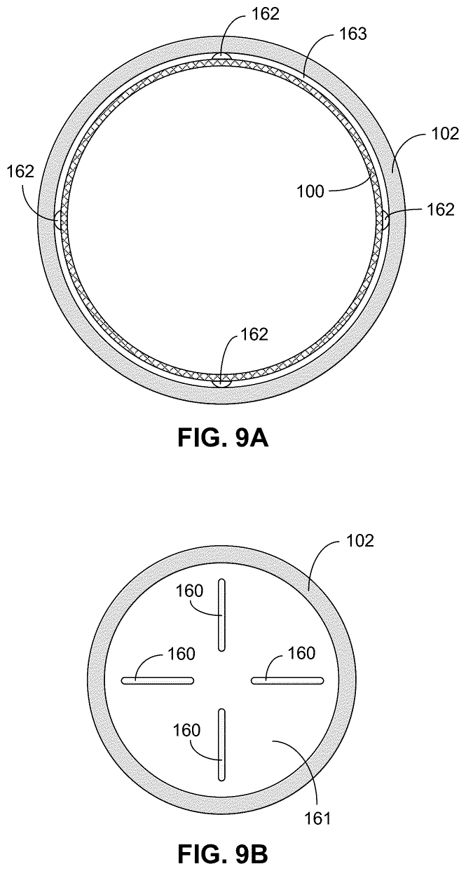

FIG. 8 shows a side sectional view of an assembly where a liner 100 is inserted into a cup 102. FIGS. 9A and 9B show sectional views indicated in FIG. 8.

Referring to FIGS. 8 and 9, in some embodiments, the example liner 100 is shown to include a plurality of features 162 formed on the outer surface of a side wall of the liner 100, and a plurality of features 160 formed on the outer surface of a bottom portion of the liner 100. The liner 100 and the features 162, 160 are shown to be dimensioned to allow the liner 100 to be seated within the cup 102 so as to provide a space 163 between outer surface of the side wall of the liner 100 and the inner surface of a side wall of the cup 102, and to provide a space 161 between outer surface of the bottom portion of the liner 100 and the inner surface of a bottom portion of the cup 102. Such spaces (163, 161) can allow the liner 100 to be inserted into and removed from the cup 102 in an easier manner without, or with a reduced likelihood of, fluid-related resistance.

Referring to the specific examples of the features 162, 160 in FIGS. 9A and 9B, four of such features are shown to be implemented along the circumferential direction relative to a longitudinal axis of the liner/cup assembly. It will be understood that different numbers of such features may also be implemented. It is also noted that in the side sectional view of FIG. 8, one side of the liner 100 is shown to include separate features 162 along the upper portion and the lower portion. It will be understood that such a group of feature(s) may include more or less number of features.

It is also noted that in the examples of FIGS. 8 and 9, the features 162, 160 are depicted as being relatively small in the circumferential direction, when compared to the spaces 163, 161 therebetween. It will be understood that the features 162, 160 can also be implemented to be larger in the circumferential direction such that the spaces 163, 161 therebetween are smaller.

In some embodiments, some or all of the features 162, 160 associated with the liner 100 can be formed as integral parts of the liner 100 utilizing, for example, and appropriate molding process.

In the examples of FIGS. 8 and 9, it is assumed that the features 162, 160 are parts of the liner 100. In such an embodiment, the corresponding cup can be an existing cup without modification having, for example a smooth inner surface.

It will be understood that in some embodiments, one or more features can also be implemented on an inner surface of the cup to allow the liner 100 to be inserted into and removed from the cup 102 in an easier manner without, or with a reduced likelihood of, fluid-related resistance. In such an embodiment, the corresponding liner can be implemented with or without features on its outer surface.

FIG. 8 also shows that in some embodiments, a liner 100 having one or more features as described herein can include a lip 168 along its upper perimeter configured to engage a surface 170 of the upper perimeter of the cup 102. Accordingly, when the liner 100 is seated within the cup 102, the lip 168 can provide an engaging surface 166 to, for example, allow formation of a seal when a blade assembly (e.g., 104 in FIG. 7) is secured onto the liner/cup assembly as described herein.

In some embodiments, the lip 168 of the liner 100 can be dimensioned to provide the foregoing sealing functionality, and to allow the liner 100 to be removed from the cup 102 in an easier manner. For example, to remove the liner 100 from the cup 102, a portion of the lip 168 can be pushed inward to separate that portion of the liner 100 from the cup 102 to facilitate the removal.

In some embodiments, the lip 168 of the liner 100 can be dimensioned to provide some or all of the foregoing functionalities, and also provide a side profile 171 that does not interfere with mechanical coupling of the liner/cup assembly with either of a coupling extender (e.g., 106 in FIG. 7) and a blade assembly 104. For example, the lateral extension of the lip 168 can be selected such that the outward lateral end of the lip does not protrude beyond the outer surface of the upper portion of the cup 102 and interfere with the mechanical coupling operation.

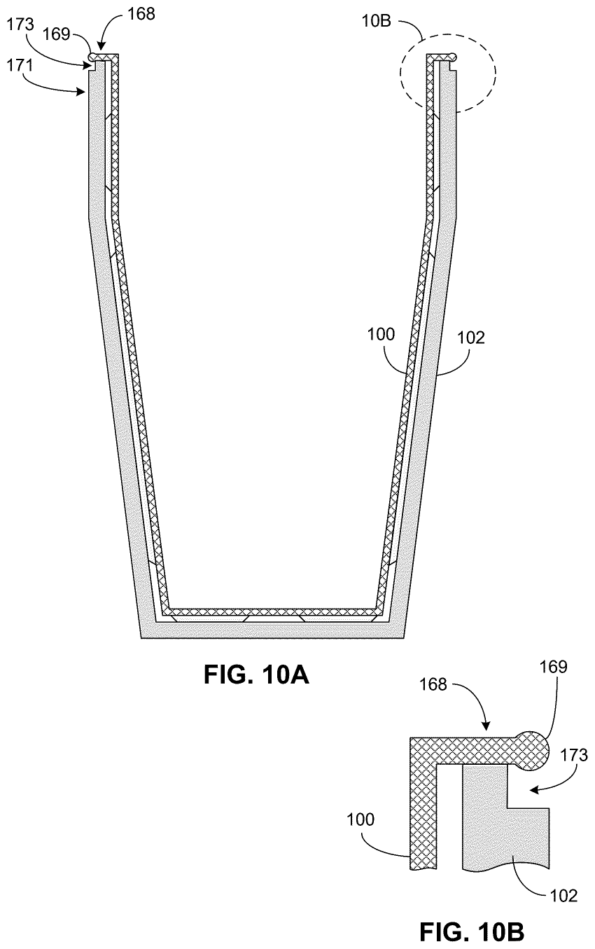

FIGS. 10A and 10B show that in some embodiments, a lip 168 of a liner 100 can include a feature 169 such as a bead implemented at an outer lateral end of the lip 168. Such a feature (169) can be dimensioned to prevent inward lateral motion of the lip 168 unless the feature 169 is actuated by a user to remove the liner 100 from the cup 102.

For example, and referring to the enlarged view of FIG. 10B, the bead 169 is shown to be positioned beyond an outer edge of the upper portion of the cup 102. In such a position of the bead 169, the lip 168 is generally inhibited from moving laterally inward relative to the upper portion of the cup 102. However, if the bead 169 is pushed slightly upward and laterally inward, the bead 169 can clear the outer edge of the upper portion of the cup 102, thereby allowing the liner 100 to be grasped easier for removal from the cup 102.

FIGS. 10A and 10B show that in some embodiments, an outer upper portion of the cup 102 can be configured to accommodate a lip-end feature 169 such as the foregoing bead structure while providing a desired side profile of the liner/cup assembly. For example, and similar to FIG. 8, it is desired to provide a side profile 171 that does not interfere with mechanical coupling of the liner/cup assembly with either of a coupling extender (e.g., 106 in FIG. 7) and a blade assembly 104. In some embodiments, such a side profile can be implemented to include a recess 173 dimensioned to accommodate a portion of the bead 169. Such a recess can be dimensioned to include the above-described outer edge of the upper portion of the cup 102 for retaining the bead 169 and such that the bead 169 does not extend outward laterally to interfere with the mechanical coupling.

In the various examples described herein (e.g., FIGS. 3-6 and 8-10), a liner 100 is depicted as having an outer surface with a side profile that is generally similar to a side profile of an inner surface of a corresponding cup 102, with or without a space (e.g., space 163 and/or 161 in FIG. 8).

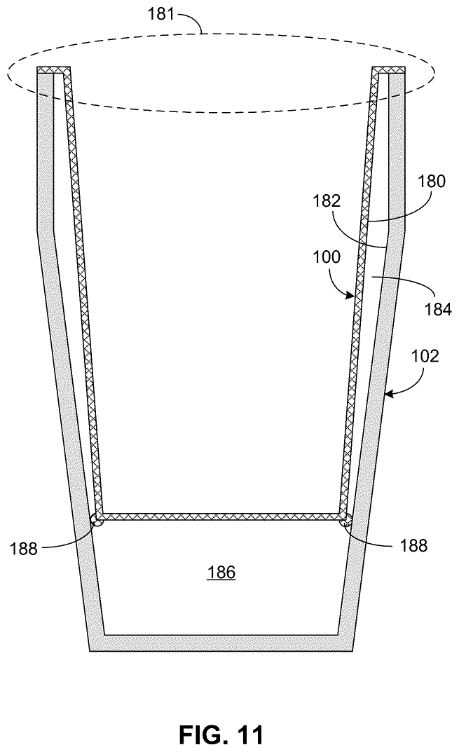

FIG. 11 shows that in some embodiments, a liner 100 having one or more features as described herein does not necessarily need to have a similar profile as that of a corresponding cup 102. For example, the liner 100 in FIG. 11 is shown to include an outer surface 180 with a side profile that is significantly different than a side profile of an inner surface 182 of the cup 102. Accordingly, in the example configuration of FIG. 11, a space 184 is shown to be provided between the walls of the liner 100 and the cup 102, and a space 186 is shown to be provided between the floors of the liner 100 and the cup 102.

FIG. 11 further shows that in some embodiments, the liner 100 can be configured to provide an upper engagement (indicated as 181) with the cup 102, similar to one or more of the examples provided herein.

In the example of FIG. 11, the lower outer portion of the liner 100 is shown to include a plurality of features 188 configured to engage the inner surface of the cup 102 and thereby provide one or more spaces between the liner 100 and the cup 102, similar to the spaces 163, 161 of FIGS. 8 and 9. As described herein, such space(s) can allow the liner 100 to be inserted into and removed from the cup 102 in an easier manner without, or with a reduced likelihood of, fluid-related resistance.

As described herein in reference to FIGS. 10A and 10B, a lip 168 of a liner 100 can include a structure 169 such as a bead structure implemented at an outer lateral end of the lip 168. Such a structure (169) can be dimensioned to prevent inward lateral motion of the lip 168 unless the structure 169 is actuated by a user to remove the liner 100 from the cup 102.

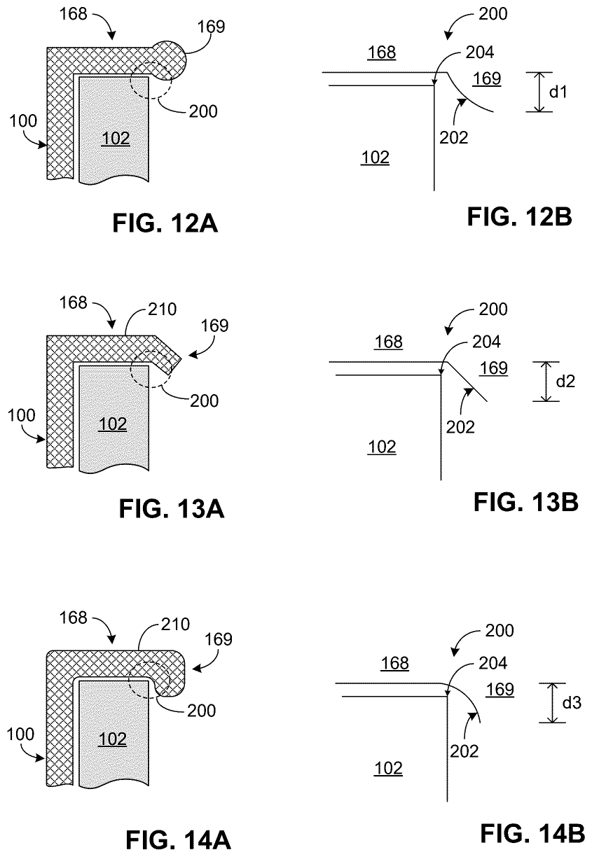

FIGS. 12 to 14 show that an end-structure of a lip of a liner having one or more features as described herein can be implemented in a number of ways, including the example bead structure 169 of FIGS. 10A and 10B. FIG. 12A shows a lip 168 of a liner 100 positioned within a cup 102 for a blender, similar to the example of FIG. 10B. It is noted that in FIG. 12A, the cup 102 may or may not include a recess (173 in FIG. 10B).

FIG. 12B shows an enlarged view of a portion 200 indicated in FIG. 12A. More particularly, FIG. 12B shows that the bead structure can be an example of a lip-end structure 169 implemented at the outer lateral end of the lip 168 to provide a convex (when viewed from the cup 102) surface 202. Such a convex surface can extend downward (when viewed as shown) by a dimension d1 to prevent inward lateral motion of the convex surface 202 beyond, for example, the outer corner 204 of the cup 102, yet still allow removal of the liner 100 from the cup 102 with application of an appropriate force by a user.

FIG. 13A shows that in some embodiments, a lip-end structure that provides the foregoing functionality can be implemented as structure different from the bead structure of FIG. 12A. For example, in FIG. 13A, a structure 169 is shown to be implemented as a downward (when viewed as shown) angled bend. Such a configuration can provide an upper (when viewed as shown) surface 210 that is generally flat without any upward-protrusions.

FIG. 13B shows an enlarged view of a portion 200 indicated in FIG. 13A. More particularly, FIG. 13B shows that the angled bend structure 169 can be an example of a lip-end structure that provides a flat or approximately flat surface 202. Such a flat surface can extend downward (when viewed as shown) by a dimension d2 to prevent inward lateral motion of the flat surface 202 beyond, for example, the outer corner 204 of the cup 102, yet still allow removal of the liner 100 from the cup 102 with application of an appropriate force by a user.

FIG. 14A shows yet another example embodiment where a lip-end structure 169 that provides the foregoing functionality can be implemented as structure that extends downward (when viewed as shown) from the outer lateral end of the lip 168. In some embodiments, such a downward extension of the lip-end structure can be at approximately 90 degrees as shown, less than 90 degrees similar to the example of FIG. 13A, or greater than 90 degrees, with respect to the lip extension direction. It is noted that in some embodiments, the foregoing configuration of the lip and the lip-end structure can provide an upper (when viewed as shown) surface 210 that is generally flat without any upward-protrusions.

FIG. 14B shows an enlarged view of a portion 200 indicated in FIG. 14A. More particularly, FIG. 14B shows that the downward extending structure 169 can be an example of a lip-end structure that provides a curved surface 202. Such a curved surface can be concave (when viewed as shown) with respect to the cup 102, and extend downward by a dimension d3 to prevent inward lateral motion of the curved surface 202 beyond, for example, the outer corner 204 of the cup 102, yet still allow removal of the liner 100 from the cup 102 with application of an appropriate force by a user.

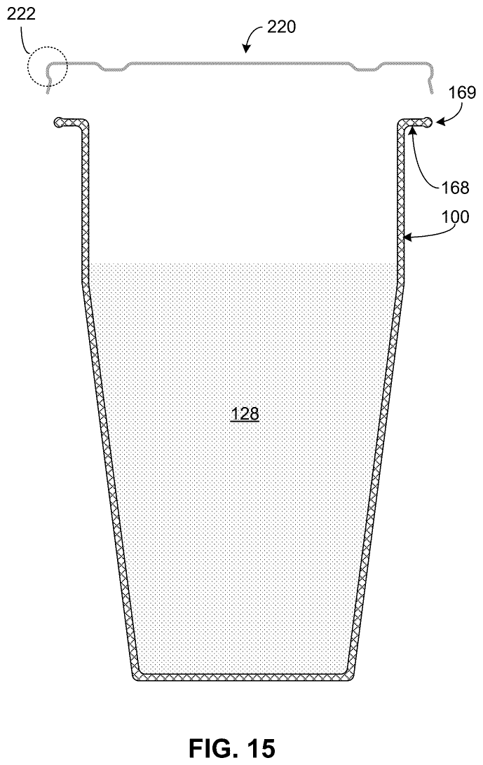

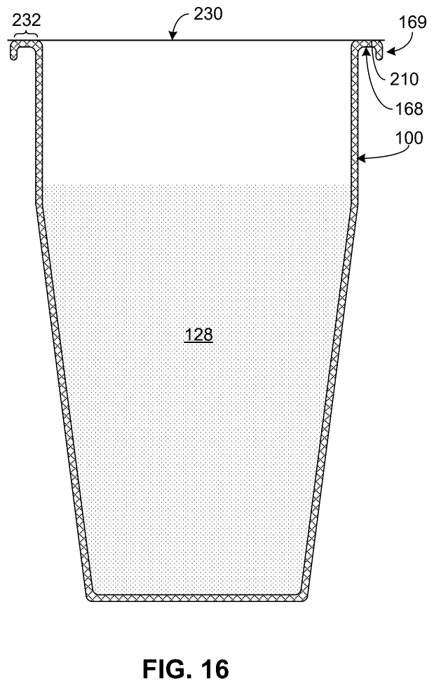

FIGS. 15 and 16 show that a liner having one or more features as described herein can be covered with a lid or a seal. For example, FIG. 15 shows a liner 100 having a lip 168 and a lip-end structure 169 implemented at the outer lateral end of the lip 168, similar to the examples of FIGS. 10 and 12. For such a liner, a lid 220 can be configured to include a receiving portion 222 at or near the lid's perimeter, where the receiving portion 222 is able to receive some or all of the lip-end structure 169 to thereby retain the lid 220 on the upper part of the liner 100. In some embodiments, the perimeter portion of the lid 220 can further be configured to allow removal of the lid 220 from the liner 100.

In the example of FIG. 15, the lid 220, when attached to the top of the liner 100, can provide desired functionalities associated with a lid for a content 128 (e.g., a blended mixture) within the liner 100. For the purpose of description, it will be understood that the lid 220 of FIG. 15 may or may not be configured to allow insertion of a straw or a similar consuming implement.

FIG. 16 shows a liner 100 having a lip 168 and a lip-end structure 169 implemented at the outer lateral end of the lip 168, similar to the examples of FIGS. 13 and 14 where a flat surface 210 is provided. For such a liner, a sealing member 230 such as a sealing film can mate with the flat surface 210 to provide a seal 232. In some embodiments, the lip 168 of the liner 100 can be configured allow formation of such a seal (232) utilizing, for example, a sealing machine.

In the example of FIG. 16, the sealing member 230, when attached to the top of the liner 100, can provide desired functionalities associated with a seal for a content 128 (e.g., a blended mixture) within the liner 100. For the purpose of description, it will be understood that the sealing member 230 of FIG. 16 may or may not be configured to allow insertion of a straw or a similar consuming implement.

In some embodiments, a kit can include a liner having one or more features as described herein. Such a kit can include a printed instruction for using the liner. For the purpose of description, it will be understood that such a printed instruction can include, for example, one or more steps printed on printable media such as paper, and/or a uniform resource locator (URL) information included with the kit (e.g., on the packaging, on a card, etc.).

In some embodiments, the above-referenced kit can further include a cup compatible for use with the liner.

In some embodiments, the above-reference kit can further include a coupling extender compatible for use with the liner; and such a kit may or may not include a cup.

In some embodiments, the above-reference kit can further include a cup compatible for use with the liner, a corresponding blade assembly, and a corresponding motor base.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A liner comprising:
a body dimensioned to fit within a cup of a blender, the body defining an inner volume and including an opening with a perimeter;
a lip extending outward from the perimeter of the opening of the body and dimensioned to engage a perimeter of an opening of the cup, such that when the liner is positioned within the cup, the resulting assembly is capable of being mechanically coupled with a blending assembly of the blender and provide a seal for the inner volume; and
a lip-end structure configured to retain the lip of the liner relative to the perimeter of the of the opening of the cup when the liner is positioned within the cup, the lip-end structure having a side-sectional shape that includes an inward-facing surface dimensioned to prevent inward lateral motion of the lip beyond the perimeter of the opening of the cup without application of a removing force.

2. The liner of claim 1, wherein the inward-facing surface of the lip-end structure includes a convex surface with respect to the opening of the cup.

3. The liner of claim 2, wherein the lip-end structure includes a bead structure having a side-sectional shape that includes the convex surface with respect to the opening of the cup.

4. The liner of claim 1, wherein the inward-facing surface of the lip-end structure includes a flat surface extending at an angle with respect to the lip of the liner.

5. The liner of claim 4, wherein the lip-end structure includes an angled bend structure having a side-sectional shape that includes the flat surface extending at the angle with respect to the lip of the liner.

6. The liner of claim 5, wherein the angle with respect to the liner is greater than 0 degree and less than 180 degrees.

7. The liner of claim 1, wherein the inward-facing surface of the lip-end structure includes a curved surface with respect to the opening of the cup.

8. The liner of claim 7, wherein the curved surface includes a concave surface with respect to the opening of the cup.

9. The liner of claim 8, wherein the lip-end structure includes a curved extension having a side-sectional shape that includes the concave surface with respect to the lip of the liner.

10. The liner of claim 1, wherein the blending assembly of the blender includes a blade assembly.

11. The liner of claim 1, wherein the body of the liner includes an inner surface and an outer surface such that the inner surface defines the inner volume and the outer surface faces an inner surface of the cup when the liner is positioned within the cup.

12. The liner of claim 11, wherein the outer surface of the body of the liner has a shape that is different than a shape of the inner surface of the cup.

13. The liner of claim 11, wherein the outer surface of the body of the liner has a shape substantially similar to a shape of the inner surface of the cup.

14. The liner of claim 13, wherein the outer surface of the body of the liner has a shape selected to provide a substantial contact with the inner surface of the cup when the liner is positioned within the cup.

15. The liner of claim 14, wherein the outer surface of the body of the liner includes one or more structures implemented to provide a space between outer surface of the body of the liner and the inner surface of the cup when the liner is positioned within the cup.

16. The liner of claim 15, wherein each of the one or more structures on the outer surface of the liner is dimensioned to reduce resistance of motion associated with trapped air when the liner is being inserted into or removed from the cup.

17. A kit comprising:
a liner including a body dimensioned to fit within a cup of a blender, the body defining an inner volume and including an opening with a perimeter, the liner further including a lip extending outward from the perimeter of the opening of the body and dimensioned to engage a perimeter of an opening of the cup, such that when the liner is positioned within the cup, the resulting assembly is capable of being mechanically coupled with a blending assembly of the blender and provide a seal for the inner volume, the liner further including a lip-end structure configured to retain the lip of the liner relative to the perimeter of the of the opening of the cup when the liner is positioned within the cup, the lip-end structure having a side-sectional shape that includes an inward-facing surface dimensioned to prevent inward lateral motion of the lip beyond the perimeter of the opening of the cup without application of a removing force; and
a printed instruction configured to facilitate use of the liner.

18. The kit of claim 17, further comprising the cup.

19. The kit of claim 18, further comprising the blending assembly.

20. The kit of claim 19, further comprising a motor base configured to allow an assembly of the blending assembly mechanically coupled to the assembly of the liner and the cup to be mounted thereon for a blending operation.
